(19) United States
(12) Patent Application Publication
(10) Pub. No.: US 2023/0240162 A1
(43) Pub. Date: Aug. 3, 2023

(54) Universal Pivoting S-Tine Mounting Bracket And S-Tine Assembly And Method Of Farming

(71) Applicant: DESERT SUNSET AG, LLC., American Falls, ID (US)

(72) Inventors: James Thomas Chapman, American Falls, ID (US); Aaron Donald Bates, American Falls, ID (US)

(73) Assignee: DESERT SUNSET AG, LLC, American Falls, ID (US)

(21) Appl. No.: 17/868,920

(22) Filed: Jul. 20, 2022

Related U.S. Application Data
(63) Continuation of application No. 63/305,710, filed on Feb. 2, 2022.

(51) Int. Cl. A01B 23/02; A01B 35/22

(52) U.S. Cl. CPC A01B 23/02; A01B 35/22

(57) ABSTRACT

An s-tine mounting bracket includes a mount plate configured for adjustability and removal attachment to a farm vehicle, a pair of parallel spaced shank bracket sides attached to the mount plate, and a tubular shank bracket end removably and adjustably attached to the shank bracket sides configured to adjustably attach an s-tine shank between the shank bracket sides. An s-tine assembly includes the s-tine mounting bracket configured for attachment to the farm vehicle, and the s-tine shank attached to the s-tine mounting bracket, with a large variety of shaped and sized s-tine shanks acceptable for use. A method of farming includes the steps of providing the s-tine assembly having the s-tine mounting bracket and the s-tine shank, attaching the s-tine assembly to the farm vehicle, and tilling a field using the s-tine assembly.

### CROSS REFERENCE TO RELATED APPLICATION

This application claims priority from U.S. Provisional No. 63/305,710, filed Feb. 2, 2022, which is incorporated herein by reference.

### FIELD

This disclosure relates to mounting brackets for farm implements and particularly to an s-tine mounting bracket. This disclosure also relates to an s-tine assembly and to a method of farming using the s-tine assembly.

### BACKGROUND

Farm implements can be attached to tractors, combines, trucks and other mobile farm vehicles. These implements can be used to perform various farming procedures such as tilling, planting, harvesting and weeding. Each type of implement requires a specific position or attitude on the farm vehicle to perform its designed procedure. Mounting brackets are used to attach the implements to the farm vehicle in an optimal operational position or in a non-operational position, such as a stowed away position. These implements and mounting brackets are typically used in combination with other implements and mounting brackets necessitating particular relational dependencies. It is desirable for an operator to be able to install and adjust implements and mounting brackets easily and without special tools.

One farming implement used mainly for tilling is referred to as an s-tine. S-tines comprise metal shanks having an s-shape. The upper portion of the s-tine attaches to a mounting bracket attached to the vehicle and the lower portion of the s-tine includes a tip portion that contacts the soil either directly or using an attachable fitting. A middle portion of the s-tine provides a spring force and vibratory action for the tip portion that fractures and mixes the soil.

The present disclosure is directed to an s-tine mounting bracket having the ability to mount a variety of s-tines with adjustability at the mount plate (e.g., up or down), at the mounting point (e.g., forward or backward), as well as the ability to pivot and stow the s-tine out of the way. The present disclosure is also directed to an s-tine assembly that includes the s-tine mounting bracket and the s-tine and optionally other farm implements. The present disclosure is also directed to a method of farming using the s-tine assembly.

### SUMMARY

An s-tine mounting bracket includes a mount plate configured for removable attachment to a farm vehicle. The farm vehicle can comprise a tractor or other motorized vehicle configured for movement through a field to perform farming procedures. The mount plate includes a plurality of vehicle mounting openings configured to receive threaded u-bolts and nuts for attaching the s-tine mounting bracket to a tool bar on the farm vehicle. Tool bars on farm vehicles typically comprise square or round tubing, and the vehicle mounting openings in the mount plate and the u-bolts are configured to accommodate different sizes of tool bars. In addition, the mount plate allows a farmer to adjust the bracket up and down by utilizing the different height settings built into the mount plate by the vehicle mounting openings.

The s-tine mounting bracket also includes a pair of parallel spaced shank bracket sides attached to the mount plate having a space therebetween, and a shank bracket end removably and adjustably attached to the shank bracket sides in the space between the shank bracket sides configured to attach an s-tine shank to the shank bracket sides. The shank bracket sides can comprise elongated flat plates having a plurality of end mounting openings for adjustably attaching the shank bracket end using end mounting fasteners and nuts. The shank bracket end can be positioned forward or backward between the shank bracket sides, which allows the position of the s-tine shank to be adjusted in axial directions along the length of the shank bracket sides. In addition, the shank bracket end is configured to allow the s-tine shank to be mounted between the shank bracket sides in an operational “down” position, or to be pivoted into a stowed “up” position between the shank bracket sides by manipulating only one end mounting fastener. The s-tine mounting bracket can also include a shank bracket gusset attached to the mount plate and to the shank bracket sides configured to rigidify the assembly. All of the elements of the s-tine mounting bracket can be installed, adjusted and operated quickly and efficiently without the need for special tools.

An s-tine assembly includes the s-tine mounting bracket configured for attachment to the farm vehicle, and an s-tine shank attached to the s-tine mounting bracket. The s-tine assembly can also include a second farm implement system, such as a tilling system or a diking system configured for attachment to the farm vehicle and configured to operate in concert with the s-tine shank.

A method of farming includes the steps of providing the s-tine assembly having the s-tine mounting bracket and the s-tine shank, attaching the s-tine assembly to the farm vehicle, positioning the s-tine shank on the s-tine mounting bracket in an operating “down” position, and tilling a field using the s-tine shank in a desired style and size. The method can also include during the positioning step, adjusting a forward or a backward position of the s-tine shank on the s-tine mounting bracket. The method can also include the step of positioning the s-tine shank on the s-tine mounting bracket in a stowed “up” position using only one fastener. The method can also include the step of performing a second farming procedure using a second farm implement attached to the farm vehicle and operably associated with the s-tine assembly. The method can also include the step of adjusting of a vertical location of the s-tine mounting bracket on the farm vehicle using a plurality of vehicle mounting openings on the s-tine mounting bracket. The method can also include the step of adjusting a depth of the s-tine shank into soil using a plurality of vehicle mounting openings on the s-tine mounting bracket.

### BRIEF DESCRIPTION OF THE DRAWINGS

FIG. 1 is an exploded perspective view of an s-tine mounting bracket illustrating the components in an un-assembled configuration;

FIG. 2 is a perspective view of the s-tine mounting bracket in an assembled configuration;

FIG. 3A is a side elevation view of an s-tine assembly illustrating the s-tine shank attached to the s-tine mounting bracket in a stowed “up” position;

FIG. 3B is a side elevation view of an s-tine assembly illustrating the s-tine shank attached to the s-tine mounting bracket in an operating “down” position;

FIG. 4 is a schematic view of the s-tine assembly that also includes a second farm implement system in the form of a planter box system;

FIG. 4A is an enlarged schematic perspective view taken along line 4A of FIG. 4 illustrating the attachment of the s-tine mounting bracket of the s-tine assembly to a tool bar attached to a farm vehicle;

FIG. 4B is a schematic drawing illustrating an exemplary planter box system of the farm implement system taken along line 4B of FIG. 4;

FIG. 4C is an enlarged schematic perspective view illustrating an s-tine shank of the s-tine assembly; and

FIG. 5 is an enlarged schematic perspective view of a second farm implement system in the form of a diking system suitable for use in the s-tine assembly.

### DETAILED DESCRIPTION

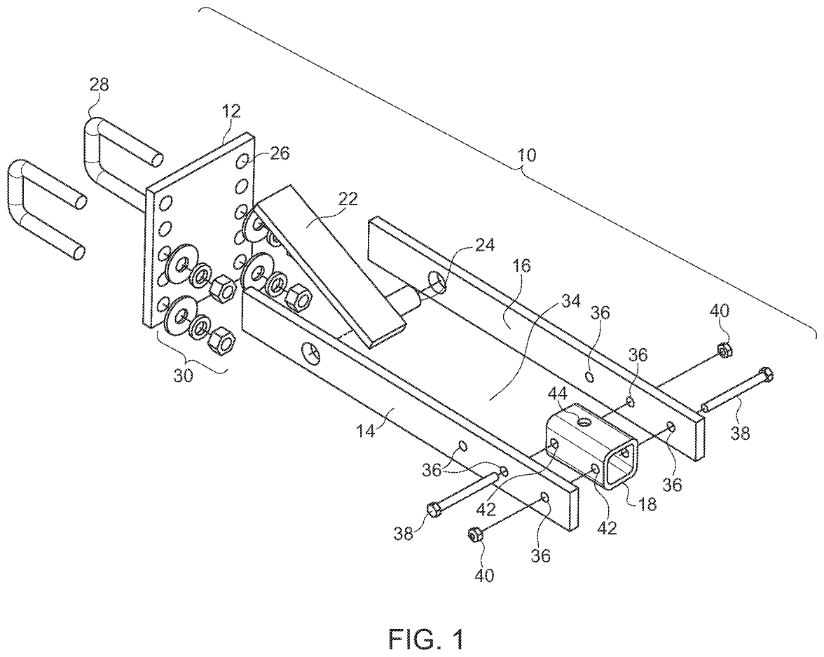

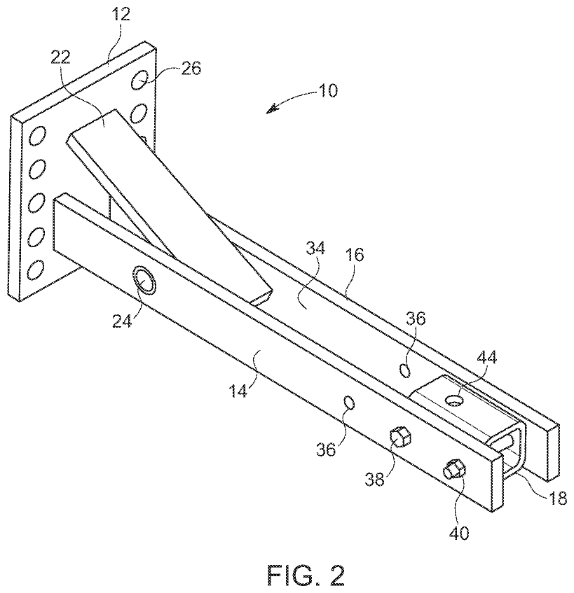

Referring to FIGS. 1 and 2, an s-tine mounting bracket 10 is shown. The s-tine mounting bracket 10 can be described as being “universal” because it has the ability to operate a variety s-tine shanks having various styles and countries of origin to till the earth, either working alone or in concert with other implements, such as tillers and dikers. In addition, the s-tine mounting bracket 10 has versatility in its attaching and adjusting functions.

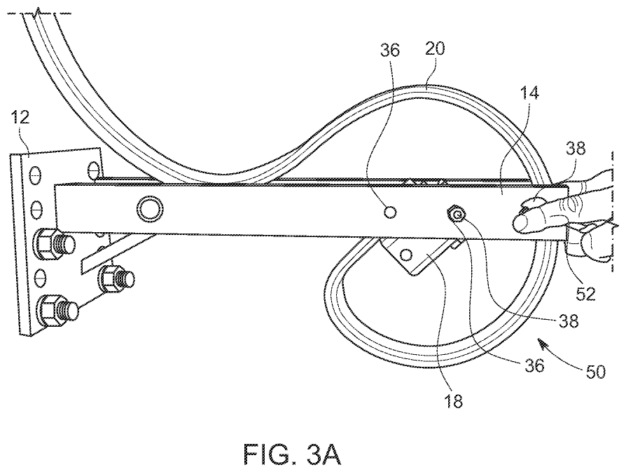

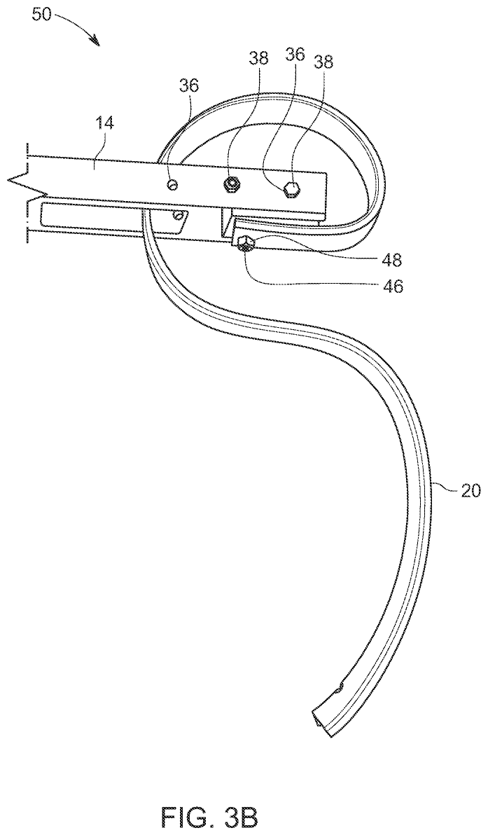

As shown in FIGS. 1 and 2, the s-tine mounting bracket 10 includes a mount plate 12, a pair of parallel spaced shank bracket sides 14, 16 attached to the mount plate 12, and a tubular shank bracket end 18 removably and adjustably attached to the shank bracket sides 14, 16 configured to attach an s-tine shank 20 (FIG. 3A) between the shank bracket sides 14, 16. It is to be understood that the s-tine shank 20 (FIG. 3A) is only one example of an s-tine shank. As will be further explained, the s-tine mounting bracket 10 is configured to accept various shaped and sized s-tine shanks from various manufacturers and countries of origin. This is an advantage over prior art s-tine brackets which typically accept only one specific s-tine shank part number. In addition, the s-tine mounting bracket 10 is configured to accept numerous sizes and styles of s-tine shanks on the market and accounts for differences related to different manufacturers and countries of origin. The s-tine mounting bracket 10 also includes a shank bracket gusset 22 attached to the mount plate 12 and to the shank bracket sides 14, 16 configured to rigidify the assembly. The s-tine mounting bracket 10 also includes a shank bracket spacer 24 attached to the shank bracket sides 14, 16 configured to further rigidify the assembly and to provide an attachment point and pivot point for additional implements (e.g., diker system).

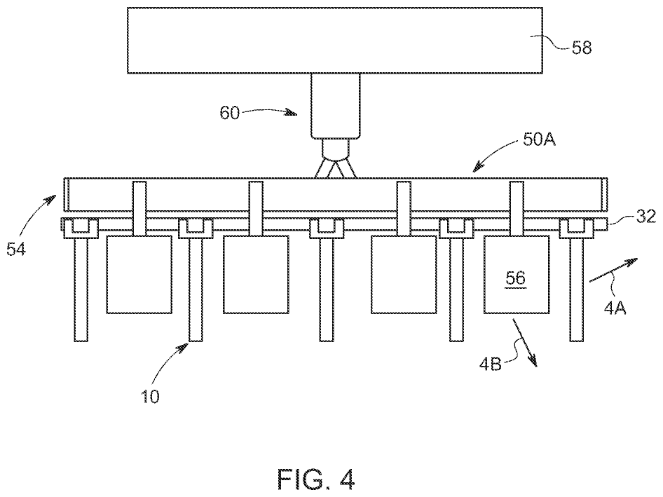

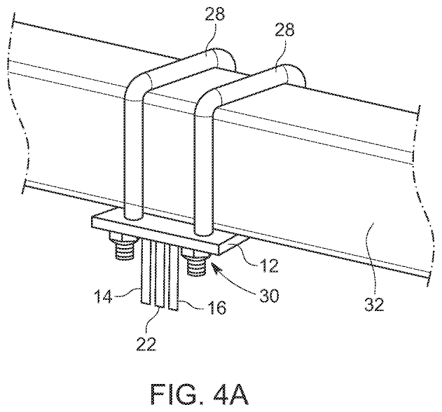

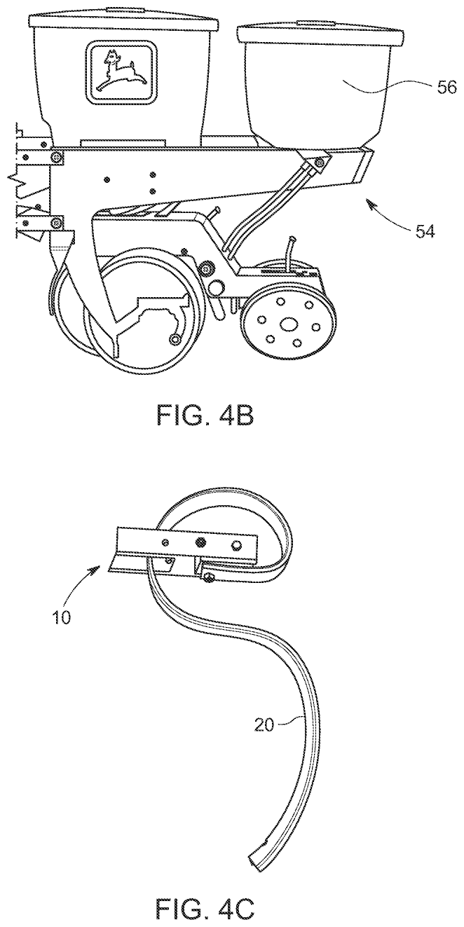

As shown in FIG. 1, the mount plate 12 includes a plurality of vehicle mounting openings 26 configured to receive threaded u-bolts 28 and washer/nuts 30 for attaching the s-tine mounting bracket 10 to a tool bar 32 (FIG. 4) on a farm vehicle 58 (FIG. 4). FIG. 4A illustrates the attachment of the mount plate 12 to the tool bar 32 of the farm vehicle 58. The mount plate 12 can comprise a metal plate having a desired thickness and peripheral outline. In the illustrative embodiment, the mount plate 12 comprises 0.5 inch (12.7 mm) thick steel plate having a rectangular outline (5.686 inch (144.42 mm)×6.0 inch (152.4 mm). In addition, the mount plate 12 can include five 0.7 inch (17.78 mm) diameter vehicle mounting openings 26 on each side spaced on 1.312 inch (33.33 mm) centers. The threaded u-bolts 28 can be 0.625 inch (15.875 mm) in diameter having 18 UNF×1.75 inch (44.45 mm) threads. The width of the u-bolts 28 can be selected as required to correspond to the size of the tool bar 32. For example, the tool bar 32 can be square tubing, such as 2 inches (50.8 mm)×2 inches (50.8 mm) square tubing to 4 inches (101.6 mm)×4 inches (101.6 mm) square tubing. The spacing of the vehicle mounting openings 26 allows different sizes of u-bolts 28 to be used to mount the s-tine mounting bracket 10 to different sizes of tool bars 32 and at different height settings. In addition, the vehicle mounting openings 26 provide adjustability in the vertical direction and allow a farmer to adjust the height, or up and down position of the s-tine mounting bracket 10. This allows the depth of the s-tine shank 20 (FIG. 3A) into the soil to be controlled by the farmer with simple adjustments using standard tools. Further, the u-bolts 28 and vehicle mounting openings 26 can alternately be configured to accommodate different sizes of tool bars 32 made of cylindrical tubing rather than square tubing.

As shown in FIG. 2, the parallel spaced shank bracket sides 14, 16 are attached to the mount plate 12 to form a space 34 therebetween. By way of example, the shank bracket sides 14, 16 can have a length of 20 inches (50.8 cm). A representative size of the space 34 between the shank bracket sides 14, 16 can be 2 inches (50.8 mm). A preferred method for attaching the shank bracket sides 14, 16 to the mount plate 12 comprises welding, performed such that the common longitudinal axis of the shank bracket sides 14, 16 is generally perpendicular to the major planar surface of the mount plate 12. The shank bracket gusset 22 can also be attached to the mount plate 12 and to the shank bracket sides 14, 16 by welding. By way of example, the shank bracket gusset 22 can comprise 0.5 inch (12.7 mm)×2 inch (50.8 mm) wide×8 inch (20.32 cm) long flat steel bar welded at an angle to the major planar surface of the mount plate 12. The shank bracket spacer 24 can also be attached to the shank bracket sides 14, 16 by tack welding. By way of example, the shank bracket spacer 24 can comprise 1 inch (25.4 mm) OD tubing tack welded to corresponding openings in the shank bracket sides 14, 16.

As shown in FIGS. 1 and 2, the shank bracket sides 14, 16 can include a plurality of spaced end mounting openings 36 aligned in matching pairs on each shank bracket side 14, 16 and configured to receive end mounting fasteners 38 passed through corresponding mounting openings 42 in the shank bracket end 18 and secured with uni-torque locking nuts 40. As will be further explained, the end mounting openings 36 allow the axial position of the shank bracket end 18 along the length of the shank bracket sides 14, 16 to be adjusted. By way of example, the end mounting openings 36 can be spaced from an end of the shank bracket sides 14, 16 by 1.5 inches (3.81 cm) for the distal end mounting openings 36, by 4 inches (10.16 cm) for the medial end mounting openings 36, and by 6.5 inches (16.51 cm) for the proximal end mounting openings 36. As used herein the term “distal” means situated farthest away from the mount plate 12. The term “proximal” means situated closest to the mount plate 12 and the term “medial” means in the middle.

As shown in FIG. 2, the tubular shank bracket end 18 is dimensioned to fit in the space 34 between the shank bracket sides 14, 16. By way of example, the tubular shank bracket end 18 can comprise steel tube having a size of 2 inches (5.08 cm)×2 inches (5.08 cm)×0.25 inch (6.35 mm) wall. The tubular shank bracket end 18 includes a shank opening 44 through the steel tube configured to attach the s-tine shank 20 to the shank bracket end 18 in the space 34 between the shank bracket sides 14, 16 using a shank bracket fastener 46 (FIG. 3B) and NYLOK nut 48 (FIG. 3B). The shank opening 44 is generally perpendicular to the end mounting openings 36.

Referring to FIGS. 3A and 3B, an s-tine assembly 50 is illustrated. The s-tine assembly 50 includes the s-tine mounting bracket 10 and the s-tine shank 20 (as the example of the s-tine shank used) attached to the s-tine mounting bracket 10 substantially as previously described. FIG. 3A is a side elevation view of the s-tine assembly 50 illustrating the s-tine shank 20 attached to the s-tine mounting bracket 10 in a stowed “up” position. FIG. 3B is a side elevation view of the s-tine assembly illustrating the s-tine shank attached to the s-tine mounting bracket 10 in an operating “down” position. As indicated by an operator's finger 52 in FIG. 3A, the s-tine shank 20 can be positioned in either the stowed “up” position or the operating “down” position by merely removing the distal end mounting fastener 38. This allows the shank bracket end 18 and the s-tine shank 20 to be pivoted between both positions. In addition, the end mounting fasteners 38 can be manipulated by removal and reinsertion in a manner that would be apparent to one skilled in the art. In FIG. 3B, the distal end mounting fastener 38 has been reinserted through the end mounting openings 36 and secured by the un-torque locking nut 40. The fastened distal end mounting fastener 38 holds the s-tine shank 20 in place in the stowed “up” position. In the operating “down” position both the distal end mounting fastener 38 and the medial end mounting fastener 38 hold the shank bracket end 18 and the s-tine shank 20 in place and resist forces during the tilling operation.

Referring to FIG. 4, FIG. 4A, FIG. 4B and FIG. 4C, an s-tine assembly 50A can also include a second farm implement system in the form of a planter box system 54 (FIG. 4B) attached to a farm vehicle 58 via implement mounting apparatus 60. The planter box system 54 (FIG. 4B) includes a plurality of planter boxes 56 (FIG. 4B) configured to operate in concert with the s-tine shank 20 (FIG. 4C).

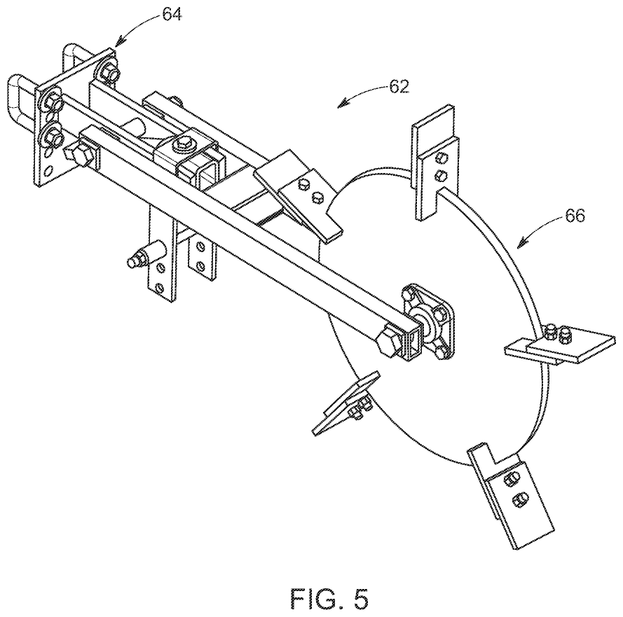

Referring to FIG. 5, the s-tine assembly 50A can also include a second farm implement system in the form of a diking system 62 having a mounting bracket 64 configured to attach to the tool bar 32 (FIG. 4) and a rotatable diker assembly 66. One suitable diking system 62 is described in U.S. Pat. No. 11,206,752 B2 entitled “Mini Diker Farm Implement System And Diking Method”, which is incorporated herein by reference.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. An s-tine mounting bracket comprising:
a mount plate configured for removable attachment and height adjustability when mounting to a farm vehicle;
a pair of parallel spaced shank bracket sides attached to the mount plate having a space therebetween, the shank bracket sides including a plurality of spaced end mounting openings configured to receive end mounting fasteners; and
a shank bracket end mounted in the space between the shank bracket sides, the shank bracket end having at least two mounting openings configured to align with the end mounting openings in the shank bracket sides for removably and adjustably attaching the shank bracket end to the shank bracket sides using the end mounting openings in the shank bracket sides and the shank bracket end mounting fasteners, the shank bracket end having a shank opening configured to attach an s-tine shank to the shank bracket end in the space between the shank bracket sides using a shank bracket fastener,
the shank bracket end configured to allow the s-tine shank to be mounted in the space between the shank bracket sides in an operational “down” position, or to be pivoted into a stowed “up” position in the space between the shank bracket sides by manipulating of the end mounting fasteners.

2. The s-tine mounting bracket of claim 1 wherein the end mounting openings in the shank bracket sides are configured to allow a location of the shank bracket end to be adjusted in an axial direction along the shank bracket sides.

3. The s-tine mounting bracket of claim 1 wherein the shank bracket end comprises square tubing.

4. The s-tine mounting bracket of claim 1 further comprising a shank bracket gusset attached to the mount plate and to the shank bracket sides configured to rigidify the shank bracket sides on the mount plate.

5. The s-tine mounting bracket of claim 1 further comprising a shank bracket spacer attached to the shank bracket sides configured to rigidify the shank bracket sides.

6. The s-tine mounting bracket of claim 1 wherein the mount plate includes a plurality of vehicle mounting openings configured to receive threaded u-bolts and nuts for attaching the s-tine mounting bracket to a tool bar on the farm vehicle, the vehicle mounting openings configured to allow adjustment of a vertical location of the s-tine mounting bracket on the farm vehicle.

7. The s-tine mounting bracket of claim 1 wherein the mount plate includes a plurality of vehicle mounting openings configured to receive threaded u-bolts and nuts for attaching the s-tine mounting bracket to a tool bar on the farm vehicle, the vehicle mounting openings configured to allow adjustment of a depth of the s-tine mounting into soil.

8. An s-tine assembly comprising:
an s-tine mounting bracket comprising:
a mount plate configured for removable attachment and height adjustability when mounting to a farm vehicle;
a pair of parallel spaced shank bracket sides attached to the mount plate having a space therebetween, the shank bracket sides including a plurality of spaced end mounting openings configured to receive end mounting fasteners; and
a shank bracket end mounted in the space between the shank bracket sides, the shank bracket end having at least two mounting openings configured to align with the end mounting openings in the shank bracket sides for removably and adjustably attaching the shank bracket end to the shank bracket sides using the end mounting openings in the shank bracket sides and the shank bracket end mounting fasteners, the shank bracket end having a shank opening;
an s-tine shank attached to the shank bracket end in the space between the shank bracket sides using a shank bracket fastener placed through the shank opening;
the shank bracket end configured to allow the s-tine shank to be mounted in the space between the shank bracket sides in an operational “down” position, or to be pivoted into a stowed “up” position in the space between the shank bracket sides by manipulating the end mounting fasteners.

9. The s-tine assembly of claim 8 further comprising a second farm implement system configured for attachment to the farm vehicle and configured to operate in concert with the s-tine shank.

10. The s-tine assembly of claim 9 wherein the second farm implement system comprises a planter box system.

11. The s-tine assembly of claim 9 wherein the second farm implement system comprises a diking system.

12. The s-tine assembly of claim 8 wherein the end mounting openings in the shank bracket sides are configured to allow a location of the shank bracket end to be adjusted in an axial direction along the shank bracket sides.

13. The s-tine assembly of claim 8 wherein the shank bracket end comprises square tubing.

14. The s-tine assembly of claim 8 further comprising a shank bracket gusset attached to the mount plate and to the shank bracket sides configured to rigidify the shank bracket sides on the mount plate.

15. The s-tine assembly of claim 8 wherein the mount plate includes a plurality of vehicle mounting openings configured to receive threaded u-bolts and nuts for attaching the s-tine mounting bracket to a tool bar on the farm vehicle, the vehicle mounting openings configured to provide adjustability in the vertical direction and to allow a farmer to adjust a height, or up and down position of the s-tine mounting bracket on the farm vehicle.

16. The s-tine assembly of claim 8 wherein the mount plate includes a plurality of vehicle mounting openings configured to receive threaded u-bolts and nuts for attaching the s-tine mounting bracket to a tool bar on the farm vehicle, the vehicle mounting openings configured to allow adjustment of a depth of the s-tine mounting into soil.

17. A method of farming comprising:
providing an s-tine mounting bracket comprising:
a mount plate configured for removable attachment and height adjustability when mounting to a farm vehicle;
a pair of parallel spaced shank bracket sides attached to the mount plate having a space therebetween, the shank bracket sides including a plurality of spaced end mounting openings configured to receive end mounting fasteners; and
a shank bracket end mounted in the space between the shank bracket sides, the shank bracket end having at least two mounting openings configured to align with the end mounting openings in the shank bracket sides for removably and adjustably attaching the shank bracket end to the shank bracket sides using the end mounting openings in the shank bracket sides and the shank bracket end mounting fasteners, the shank bracket end having a shank opening;
an s-tine shank attached to the shank bracket end in the space between the shank bracket sides using a shank bracket fastener placed through the shank opening;
the shank bracket end configured to allow the s-tine shank to be mounted in the space between the shank bracket sides in an operational “down” position, or to be pivoted into a stowed “up” position in the space between the shank bracket sides by manipulating the end mounting fasteners;
attaching the s-tine assembly to the farm vehicle;
positioning the s-tine shank on the s-tine mounting bracket in the operating “down” position; and
tilling a field using the s-tine shank in a desired style and size.

18. The method of claim 17 further comprising positioning the s-tine shank on the s-tine mounting bracket in a stowed “up” position using only one of the end mounting fasteners.

19. The method of claim 17 further comprising performing a second farming procedure using a second farm implement attached to the farm vehicle and operably associated with the s-tine assembly.

20. The method of claim 17 further comprising during the positioning step adjusting a forward or a backward position of the s-tine shank.

21. The method of claim 17 further comprising adjusting of a vertical location of the s-tine mounting bracket on the farm vehicle using a plurality of vehicle mounting openings on the mount plate.

22. The method of claim 17 further comprising adjusting a depth of the s-tine shank into soil using a plurality of vehicle mounting openings on the mount plate.
